(19) United States
(12) Patent Application Publication
(10) Pub. No.: US 2003/0225764 A1
(43) Pub. Date: Dec. 4, 2003

(54) Method and system for displaying data in a collaborative work environment

(76) Inventors: Keith W. Smith, Prosper, TX (US); Roland Sobrepena, Arlington, TX (US)

Correspondence Address: HUGHES & LUCE LLP, 1717 MAIN STREET, SUITE 2800, DALLAS, TX, 75201, US

(21) Appl. No.: 10/157,694

(22) Filed: May 29, 2002

(51) Int. Cl. G06F 7/00

(52) U.S. Cl. 707/9

(57) ABSTRACT

The invention is directed to a system for displaying data in a collaborative work environment. The system may include a server, a database, and an accessing browser. A user may provide to the server an identification. The identification may be associated with access permissions to the data. The server may then retrieve a set of requested data and compile an instruction file such as a web page. The instruction file may display the data in two panels. One panel may provide a subset of the data in an editable format. Another panel may provide a second subset of the data in a read-only format. Both panels are displayed in a single window or screen. The user may then edit the editable data and submit it to the server. In addition, a second user may access the data such that the subset of the data is provided in a read-only format and the second subset in an editable format. In this manner, various users with differing responsibilities for subsets of data may view the data in a single window.

### TECHNICAL FIELD OF THE INVENTION

This invention relates in general to a system and method for displaying customer data for use in a collaborative work environment. More specifically, the invention relates to a system and method for displaying customer data to multiple users with varying editing permissions through a web-based interface.

### BACKGROUND OF THE INVENTION

Many industries rely on collaboration between various participants. Often, each participant has a different job function. As such, each participant may be responsible for a subset of the data the must be shared among the collaborating group. Such industries may include real estate, banking, and government administration, among others.

Typical solutions require each participant to complete forms in hard copy. The forms may be mailed, faxed, or delivered to other participants. Other participants may then utilize the information on the forms to complete their job function or additional forms. As such, completing the task assigned to the group is slowed by lengthy delivery times. In addition, the process may be cumbersome as the participants must gather information from various forms on various locations or various sheets.

Other typical solutions attempt to automate the process. However, these solutions often simply incorporate electronic versions of the forms. In some instances, only one participant may work with a form at a given time. Thus, participants must still gather information from various forms on various sheets and screens. Therefore, the process remains cumbersome.

As such, many typical solutions for collaboration suffer from lengthy cumbersome processes. Many other problems and disadvantages of the prior art will become apparent to one skilled in the art after comparing such prior art with the present invention as described herein.

### SUMMARY OF THE INVENTION

Aspects of the invention are found in a system for electronically delivering information to multiple users on a single screen. The single screen may have multiple panels. Each panel may display data associated with completing the task assigned to a user. Furthermore, one or more panel may be editable while other panels are not. Editing permission may be granted in association with the users job function or identification.

In one exemplary embodiment, the system may be a server in communication with a web browser through an interconnected network. The server may have instructions to permit a user to login and provide a user identification. Further, the server may have instructions for accessing a database. In addition, the server may have instructions for creating an instruction file which includes data retrieved from the database. The instruction file may be interpreted to display one subset of the data in an editable format and another subset of the data in a read-only format. Furthermore, the instruction file may be interpreted to display the editable data in one panel and the read-only data in another panel. However, both panels may be contained in the same screen. The instruction file may be delivered to a browser for interpretation.

Aspects of the invention may also be found in the system wherein a second user may login and access the information. The system may create another instruction file. The other instruction file may function to display a differing set of data, or the same data with differing edit permissions. The data may be subsequently updated as each user changes associated editable data. Further, the display may be updated with periodic requests or on demand.

Further aspects of the invention may be found in a method for displaying the information to the user. The user may login to a system. The system may access a database and retrieve data. The data and its format may be associated with the user login and/or the users job function. The system may create an instruction file that displays one subset of the data in an editable format. Additionally, the instruction file may be interpreted to display another subset of the data in a read-only format. The editable data may be displayed in one panel and the read-only data in another panel. However, both panels may be contained in the same screen. The screen, panels, and data may be updated with periodic requests or on demand.

Another aspects of the invention may be found in a browser operable to interpret an instruction file associated with a work process. The instruction file may display data. The data may have a first subset that is editable and a second subset that is read-only. The first subset may be displayed in one panel and the second subset may be displayed in another panel. However, both panels may be found on a single screen. The nature of the data in each of the subsets may be associated with a user identification or job function. Furthermore, the display, screen, panels, and data may be updated with periodic request or on demand.

As such, a system for displaying data in a collaborative work process is described. Other aspects, advantages and novel features of the present invention will become apparent from the detailed description of the invention when considered in conjunction with the accompanying drawings.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIG. 1 is a schematic block diagram of a system according to the invention;

FIG. 2 is a block diagram of an exemplary embodiment of a screen according to the invention;

FIG. 3A is a block diagram of an exemplary embodiment of a screen as seen in FIG. 2;

FIG. 3B is a block diagram of an exemplary embodiment of a screen as seen in FIG. 2;

FIG. 3C is a block diagram of an exemplary embodiment of a screen as seen in FIG. 2;

FIG. 4 is a process flow schematic of an exemplary system as seen in FIG. 1;

FIG. 5 is a block flow diagram of an exemplary method for use by the system of FIG. 1;

FIG. 6 is a schematic block diagram of an exemplary embodiment of a database structure for use in the system as seen in FIG. 1;

FIG. 7 is a schematic block diagram of an exemplary embodiment of a dataset for use in the system as seen in FIG. 1;

FIG. 8 is a process flow schematic of an exemplary embodiment of the system as seen in FIG. 1;

FIG. 9 is a process flow schematic of an exemplary embodiment of the system as seen in FIG. 1;

FIG. 10 is a process flow schematic of an exemplary embodiment of the system as seen in FIG. 1;

FIG. 11 is a process flow schematic of an exemplary embodiment of the system as seen in FIG. 1;

FIG. 12 is a process flow schematic of an exemplary embodiment of the system as seen in FIG. 1;

FIG. 13 is a process flow schematic of an exemplary embodiment of the system as seen in FIG. 1;

FIG. 14 is a process flow schematic of an exemplary embodiment of the system as seen in FIG. 1;

FIG. 15 is a process flow schematic of an exemplary embodiment of the system as seen in FIG. 1;

FIG. 16 is a process flow schematic of an exemplary embodiment of the system as seen in FIG. 1; and

FIG. 17 is a process flow schematic of an exemplary embodiment of the system as seen in FIG. 1.

Corresponding reference numerals indicate corresponding parts throughout the several views of the drawings.

### DETAILED DESCRIPTION OF THE PREFERRED EMBODIMENT

The invention is directed to a system and method for displaying data in collaborative work environment. In one exemplary embodiment, the collaborative work environment may be an interconnected network in which users access a data through a server and database.

The user may be presented with an inter-networked collaborative work environment that permits assigning specific tasks to specific persons. The work environment may present the collaborative framework on a single screen display so that users may access the necessary information. To effectuate the present invention's methodology, various assignable access keys are designated to users of the collaborative process. The keys allow these users to edit only those portions of the data for which they retain data entry responsibility. At the same time, the assignable keys allow users to access other data in a read-only format. The data may be presented together on a single screen, thus, simplifying the exchange of data.

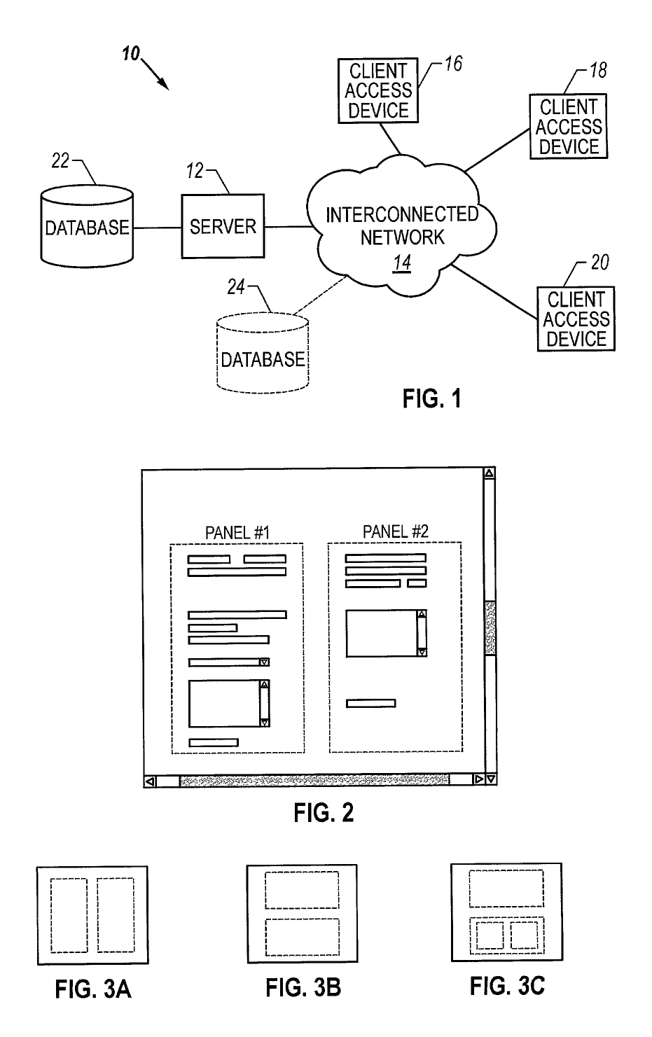

FIG. 1 depicts a system according to the invention. In the system 10, a server 12 may be accessed by client access devices 16, 18, and 20 through an interconnected network 14. The server 12 may access a database 22 or 24 and compile the data into an instruction file. The instruction file may then be delivered to a client 16, 18, or 20. Alternately, the server 12 may deliver an instruction file to the client access device 16, 18, or 20 that includes information for accessing the database 22 or 24. However, the system may have some all or none of the elements. Further, these elements may be associated in various combinations.

The server 12 may take various forms. These forms may include computational circuitry that runs in accordance with various operating systems. These operating systems may include MacOS®, Linux®, BSD®, Unix, Windows NT®, and Window 2000®, among others. In addition, the server may run various software including HTML servers, data accessing, data processing, server side scripting, server side code interpretation, and open connection software, among others. However, various operating systems, software, and server systems may be used.

The interconnected network 14 may take various forms. These forms may include LAN, WAN, and global networks access through various hardwired and wireless connections such as Ethernet, Wireless Ethernet, BlueTooth®, phone lines, cellular system, pager systems, two-way pager systems, wireless multiplexing systems, USB, serial connection, and parallel connections, among others. Further, the interconnected network may communicate using various standards and protocols including HTTP, FTP, SNMP, and various wireless connection standards, among others. The interconnected network 14 may also utilize various combinations of connections and standards. However, some, all, or none, of these elements and standards may be used.

The client access devices 16, 18, and 20 may take various forms. These forms may include desktop system, wireless systems, PDAs, smart phones, and laptop systems, among others.

The databases 22 and 24 may take various forms, these forms may include various SQL server, databases, tables, spreadsheets, and text files, among others. For example, the database may take the form of a Microsoft® SQL Server 7.0, mySQL, an Access® database, a database by ORACLE®, an Excel® Spreadsheet, a text file, or a binary file, among others. Further, the database 22 or 24 may reside on the server 12, separate from the server 12, or accessible through the interconnected network 14. However, various database may be used and accessed from various locations or in various combinations.

In one exemplary embodiment, a user may access the server 12 from a client access device 16 through the interconnected network 14 and request data such as customer data. The user may provide an access identification. The access identification may be associated with responsibilities for data. The server 12 may then retrieve the requested data from a database 22 or 24. Further, the server 12 may compile an instruction file for delivery to the client access device 16. The instruction file may be interpreted by the client access device 16 to display the data in subsets having various editing permissions. In addition, these subsets may be displayed in more than one panel, the panels associated with the editing permissions. However, the panel may form a part of a single window or screen displayed on the client access device 16. Furthermore, the instruction file may provide the client access device 16 with the ability to update editable data and relay the edited data to the server 12 or database 22 or 24. In addition, a second user may access the system with a second access identification and receive the data with alternate access permissions and displayed in alternate panels. However, the client access device 16, server 12, and database 22 and 24 may interact in various manners.

In one exemplary embodiment, the client access device 16 may, through a browser, send an HTTP request to the server 12 through a global network. The client access device 16 may also provide an identification of the user and a request for data associated with a customer. The server 12 may access the database to acquire the requested data. In this exemplary embodiment, the server 12 may access an interpreted web page such as may be encoded in ColdFusion®, ASP®, or PHP, among others. The interpreted web page may direct a request for subsets of data associated with the customer to be retrieved with various editing permissions and displayed in various cells of a table in a compiled HTML page. The data may be retrieved from a SQL Server 7.0 database and provided to the server for inclusion in the web page.

However, the system may use various access methods such as FTP, SNMP, and HTTP, among others; various coding methods for creating an instruction file such as PERL, server side Java® scripting, ASP®, PHP, ColdFusion®, compiled C, and Visual Basic® scripting, among others,; various databases and database access methods; and instruction file formats such as Java, HTML, XML, FTP data, and binary data, among others. These elements may be used in various combinations to deliver a collaborative work environment.

In this manner, data may be displayed to various users in a collaborative work environment. Each user may have access to and see all of the data in a single window. However, the user may be provided editing permission to a limited subset of data for which the user is responsible. Further, multiple users may access a record without requiring record locking.

FIG. 2 depicts an exemplary embodiment of a window or screen provided to a user. Instructions interpretable to display the window or screen may be supplied by the server. For example, the instructions may be provided in HTML or XML. For example, the server may interpret a ColdFusion® instruction file to derive an HTML file. However, various methods may be used to interpret the instruction file and deliver the instructions.

In FIG. 2, Panel #1 may display a subset of customer data with editing permissions. Panel #2 may display a second subset of the customer data with read-only permissions. The display may permit manipulation and uploading of the editable data. Further, the display may be updated to show the most recent data by accessing the server and retrieving another instruction file.

The panels and data subsets may be organized in various manners. FIGS. 3A, 3B, and 3C show various arrangements of the panels. For example, the panels may be side-by-side, as seen in FIG. 3A. Alternately, the panels may be arranged vertically, as seen in FIG. 3B. Further, several panels may be displayed and panels may be nested as seen in FIG. 3C. However, various numbers of panels and various arrangements of panels may be envisaged.

In this manner, a user of a collaborative work environment may have access to the data in a single screen and manipulate the data for which the user is responsible. In addition, the data may be updated with periodic requests, on demand, as changed, or in other manners.

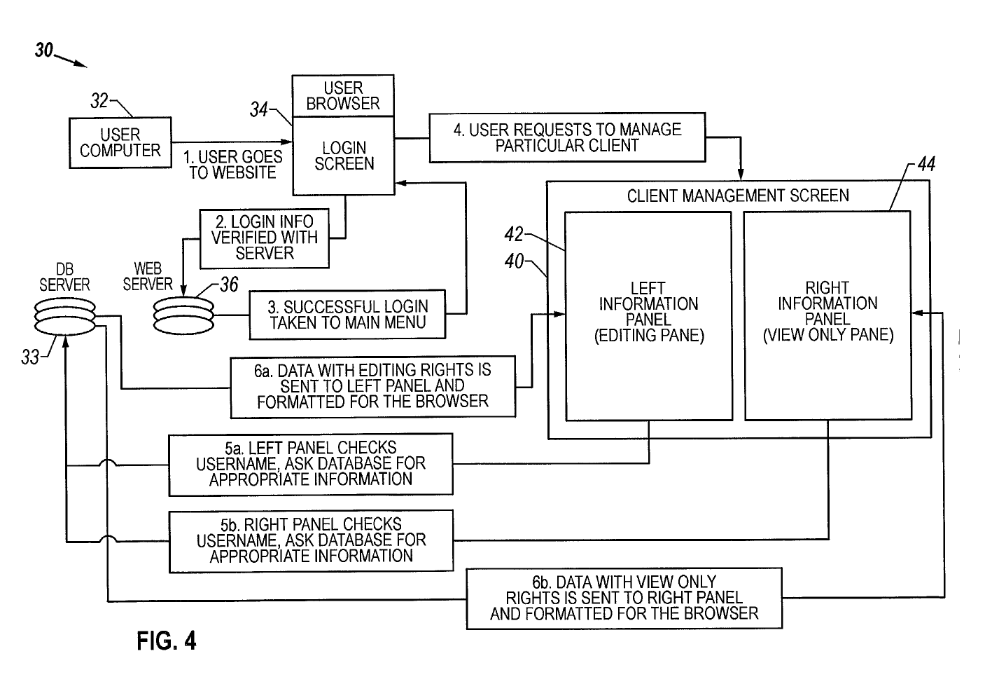

FIG. 4 depicts a process flow of an exemplary embodiment of the system. As seen, a user may access a login screen 34 from a computer 32. The user may provide a server 36 login information including an identification that may be associated with access permissions. The server may provide the user with information about what customer data is accessible by the user. The user may then request a web page 40 that has selected customer data.

The server may, for example, interpret a ColdFusion® page to determine what information is to be provided and in which panel. However, the page may be formulated using server scripts, ASP®, PHP, or other methods. Data may then be requested from the database server 38. The database server may provide data for the page 40 in subsets associated with access and editing permissions. For example, editable data may be provided for use in a first panel 42 and read-only data may be provided for use in a second panel 42. The page may then be sent to the computer 32.

However, the server 36 and database server 38 may be separate or together. Various coding methods may be used to created the page 40 and various arrangements of the page 40 may be envisaged.

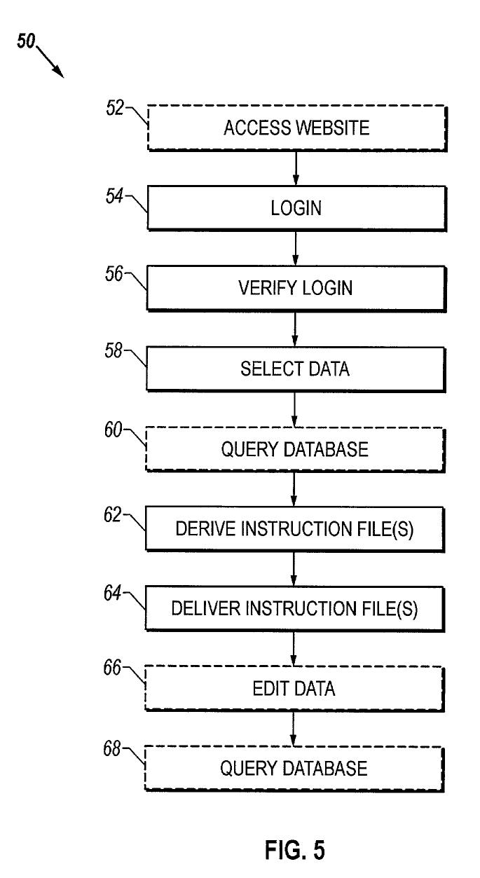

FIG. 5 is a block flow diagram of an exemplary method for use by the system. In the method 50, a user may access a website as seen in a block 52. However, various other means of access may be envisaged. The user may login to the system as seen in a block 54. This login may provide the system with an identification that may be associated with data access and editing permissions.

In a block 56, the server may verify the login and provide the user with options. The user may then select data such as data associated with a customer as seen in a block 58. However, the data may take various forms including personal information, personnel information, and process related data, among others.

In response to the user's selection, the server may access the database to acquire the data as seen in a block 60. Then, the server may derive and deliver an instruction file. However, the server may alternately access the database in conjunction with deriving and delivering the instruction file.

As seen in a block 62, the server may derive an instruction file. The instruction file may take the form of an HTML page, XML page, or binary file. This may be performed through the use of server side programs or scripts. In one exemplary embodiment, the server may interpret a file encoded in ColdFusion®, ASP®, or PHP, among others. However, the server may alternately use a scripting method, among others. The accessing of the database may be occur before, in coordination with, or after the derivation of the instruction file.

Next, the instruction file may be delivered to the client or user as seen in a block 64. This may be accomplished through an interconnected network such as a global network. However, various networks may be utilized and the file may be delivered using various protocols and combinations of protocols including HTTP or FTP, among others.

Further, the user may edit the data delivered with editing permissions and provided that data to a database or to the server. In this manner, a user may view data while manipulating data for which the user has editing responsibility.

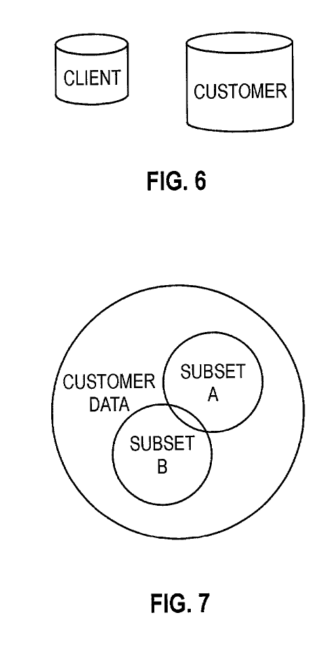

The database may have various structures. FIG. 6 shows an exemplary embodiment in which a database with information associated with user or client access may be stored in a separate database from a customer information database. However, these databases may be together, separate, or in separate tables of the same database, among others. In one exemplary embodiment, a user provides login information that is compared with the client database to determine job function and data responsibility. The user is then given access and editing permissions to the appropriate customer information.

The customer information may be further subdivided into subsets. As seen in FIG. 7, the customer data may be subdivided in to two subsets, among others. These subsets may or may not overlap. In this exemplary embodiment, various users may have editing rights to some information and read-only rights to other information. For example, one user may have editing rights to subset A and read-only rights to subset B. However, a second user may have read-only rights to subset A and editing rights to subset B. The subsets may overlap and business rules may be used to determine what permissions to apply to the overlap. However, the subsets may or may not overlap. In additions, other subsets may exist in the customer data. Various users may be provided various permissions to access various subsets.

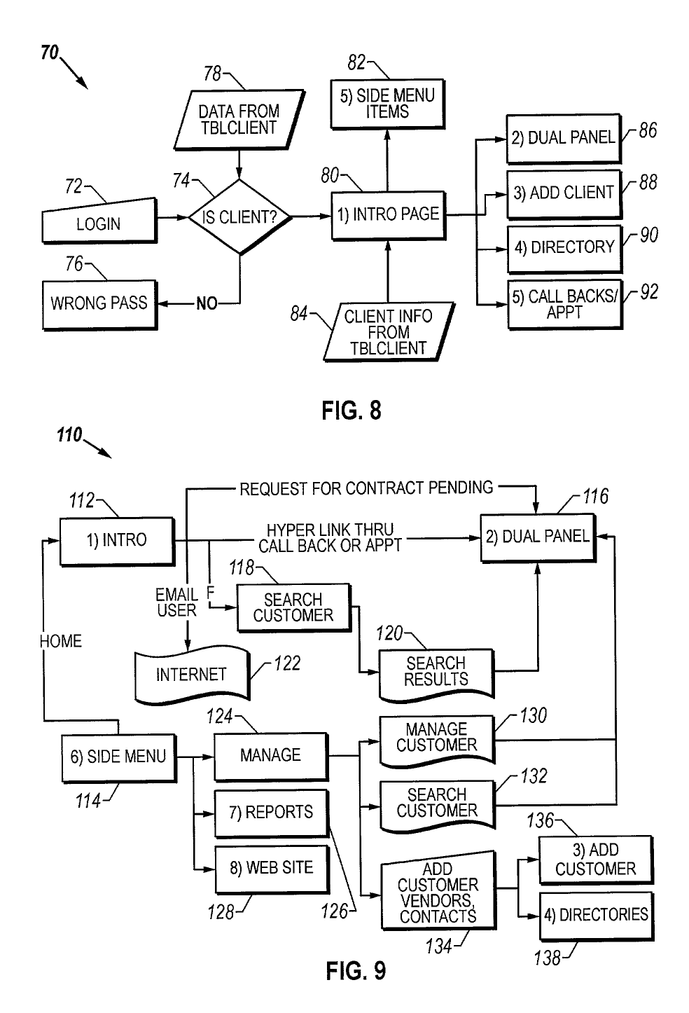

FIG. 8 depicts a further exemplary embodiment of a process flow of information through the system. In the FIG. 8, the user may login to the system as seen in a block 72. A server may determine if the user is a client by accessing a client table 78 in a database. If the user is not a client, the system may prevent access as seen in a block 76.

The determination may also include a determination of job function. This determination may be used in determining the style, format, and display of data accessed by the user. If the user is a client, the system may provide an introduction page 80. From the introduction page, the user may have access to various other pages including a dual panel page 86, an page for adding and editing client information 88, a directory 90, a scheduling page for call backs and appointments 92, and various side menu and administrative tasks. The nature of the introduction page 80 and the access options may be determined by accessing the client table 84.

Turning to FIG. 9, from the introductions page 112 a user may be provided links to various pages. The nature of the links and the style of the pages found in the link may be related to the identification or job function of the user.

For example, the user may be provided with a dual panel page of customer data 116. The customer may, for example, be a customer to a real estate transaction, a bank transaction, a government process, or a combination of these, among others. In this case, the user may access customer information on a dual panel screen 116 during a call back or appointment or determine a status of a contract or transaction. In the process of requesting the dual panel screen, a server may search a customer database 118 and present the search results 120 for use in the dual panel screen 116.

From the introduction page 112, the client or user may also be presented other options. For example the user may be presented with the option to contact or email other users 122, clients, or customers.

In addition, each page may have a side menu 114 giving the option to return to the introduction page, to manage the customer database 124, build reports 126, and access other sites 128, among others. For example, the side menu may permit access to a page for managing the customer database 130. This management page 130 may provide a means for searching, adding, deleting, amending, and establishing links between clients and customers, and assigning customers to clients, among others. Further, the management page 124 may provide access to other pages for adding customers and presenting directories of customer and client contact information. However, the side menu 114 and management page 124 may have other envisaged uses.

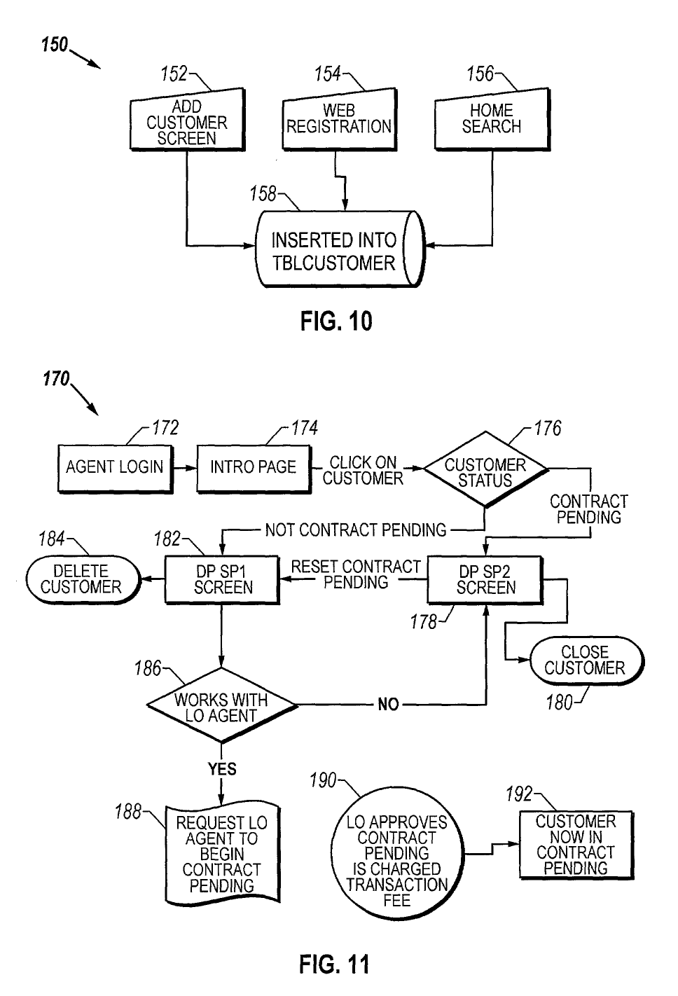

In one exemplary collaborative environment, a real estate transaction may be performed in a collaborative work environment. This transaction may involve various users such as government agencies, real estate agents, loan officers, title companies, and appraisers, among others. In the examples seen in FIGS. 10 through 17, a collaboration between a real estate agent and a loan officer will be used. However, the invention may be used for various collaborations and data combinations in various envisaged industries.

FIG. 10 depicts access to a customer table or table set in a database 158. In this example, a real estate agent accesses and edits various customer data. FIG. 10 depicts potential access locations. For example, the real estate agent may add customers from an Add Customer Screen 152. Alternately, a customer may register with the agent and be added to the database through a Web Registration Screen 154. Further, the agent may access customer information or select the information from various pages including an introduction page and Home Search page 156, among others.

FIG. 11 depicts one exemplary embodiment of the data flow associated with the activities of the agent. In this exemplary embodiment, the agent may login, as seen in a block 172, and view an introduction page 174. In the login, the agent may provide an identification that enables the system to determine that the user in an agent. This determination may be used in determining how to present the data.

The agent may select a customer data set with which to work. The system may determine the status of the customer as seen in a block 176. If the customer has a contract pending, a dual panel screen 178 may be displayed and worked with to complete the customers data set. Once the data set has been complete, the agent may close the customer as seen in a block 180.

Alternately, if the no contract is pending, a differing set of data may be displayed in a dual panel screen 182. The screen may permit deletion of the customer as seen in a block 184. Alternately, the screen may permit an agent to assign a loan officer to the customer or transfer data or a message to the loan officer indicating a need for collaboration as seen in a block 186. If the loan officer is not part of the collaborative work environment or the loan office is not interested in working with the client or the customer, the agent may be directed to a dual panel screen 178 for completion of the file and closing the customer file. Further, the agent may be directed to use another form of collaboration.

However, if the loan officer is able and willing to work with the agent and the customer, the loan officer may be given access to the customer information to begin processing a loan as seen in a block 188. Once the data for which the loan officer is responsible is complete, the status of the customer may be changed as seen in a block 192.

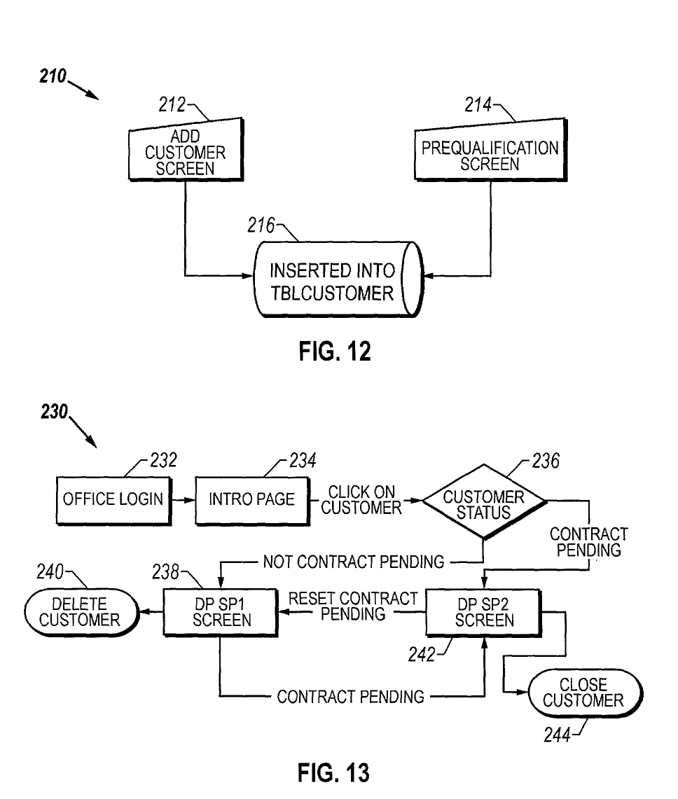

FIG. 12 depicts a similar exemplary embodiment from the view of a loan officer. In this exemplary embodiment, the loan officer may access data 216 through an Add Customer Screen 212 or a Pre-qualification Screen 214, among others.

FIG. 13 presents data flow for the actions of the loan officer. The officer may access a login, as seen in a block 232, and be provided with an introduction page 234. The loan officer may then select a customer. If the customer does not have a contract pending, the loan officer may be provided with a dual panel screen 238 with options to delete the customer, as seen in a block 240, or change the status of the customer.

Alternately, the loan officer may be provided with a dual panel screen 242 if a contract is pending. The dual panel screen 242 may permit the officer to complete work associated with the customer, the contract, and the data and close the customer, as seen in a block 244. Alternately, the officer may change the status of the customer to indicate no pending contract.

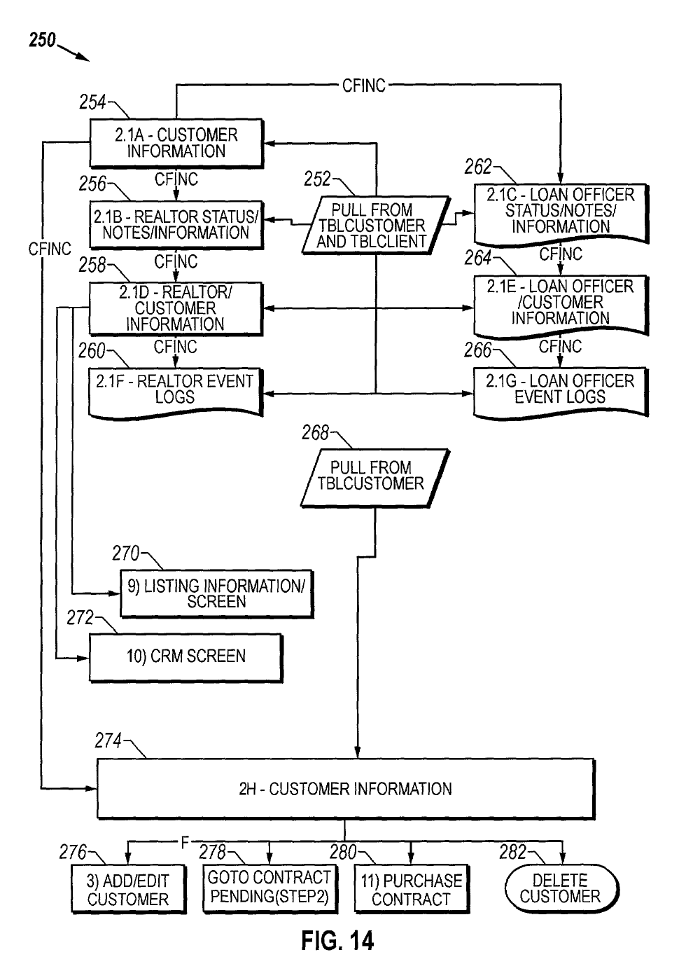

Continuing with the exemplary embodiment of the collaboration between a loan officer and a real estate agent, FIG. 14 shows the data flow for the building of a screen relating to a customer for an agent wherein the customer is a prospect and does not have a contract pending. In this example, a query 252 that draws data from a customer and a client table may provide editable data regarding Customer Information 254, Realtor Notes 256, Realtor/Customer Information 258, and Realtor Event Logs 260. The query or a separate query may also provide information in an read-only format such as Loan Officer Status 262, Loan Officer/Customer Information 264, and Loan Officer Event Logs 266. Some, all, or none of these may be provided. Further, these may be provided in various groupings with various permissions.

In addition, a query 268 to the customer table may provide functionality 274 or options for changing customer information, adding a customer, changing contract status, accessing contracts, deleting the customer. This data may also include contact information.

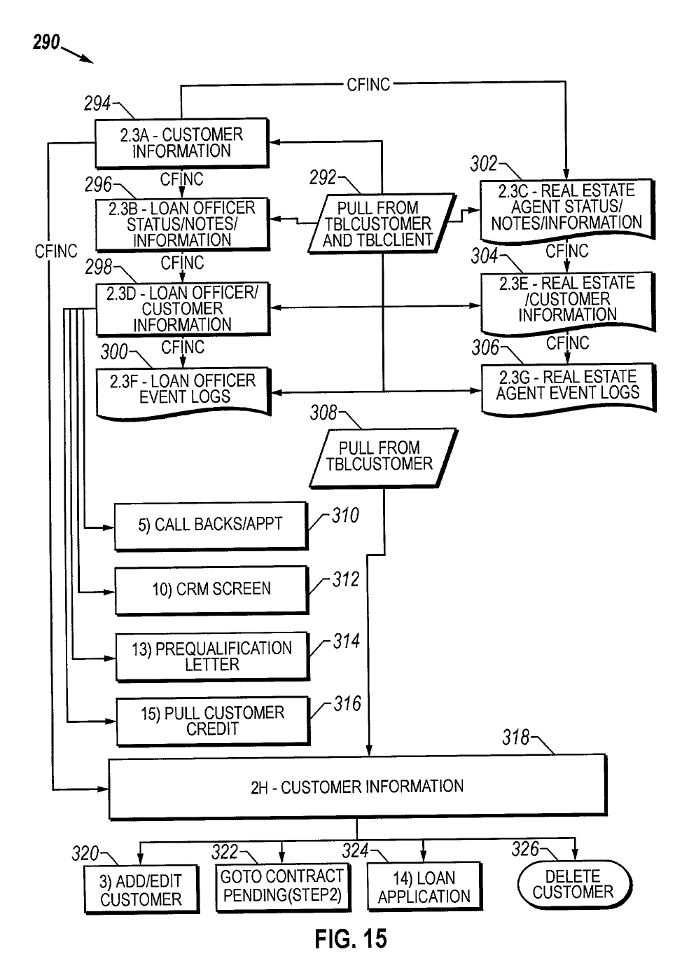

Data flow for the loan officer may be different. FIG. 15 presents the data flow for a prospecting loan officer. In this case, the query or queries 292 drawing data from the customer and client tables may be presented with editing permissions similar or differing from those presented to the realtor. For example, the loan officer may be presented with editing access to the Customer Information 294 but may have editing rights to the Loan Office Status 296, Loan Officer/Customer 298, and Loan Officer Event Logs 300 and not the Real Estate Agent Status 302, Real Estate/Customer 304, and Real Estate Event Logs 306. Further, links from the Loan Officer/Customer information 298 may be the same or differ from those provided to the Realtor in accordance with the differing job function.

In addition, a query to the customer table may provide functionality 318 or options for changing customer information, adding a customer, accessing applications, deleting the customer. This data may also include contact information.

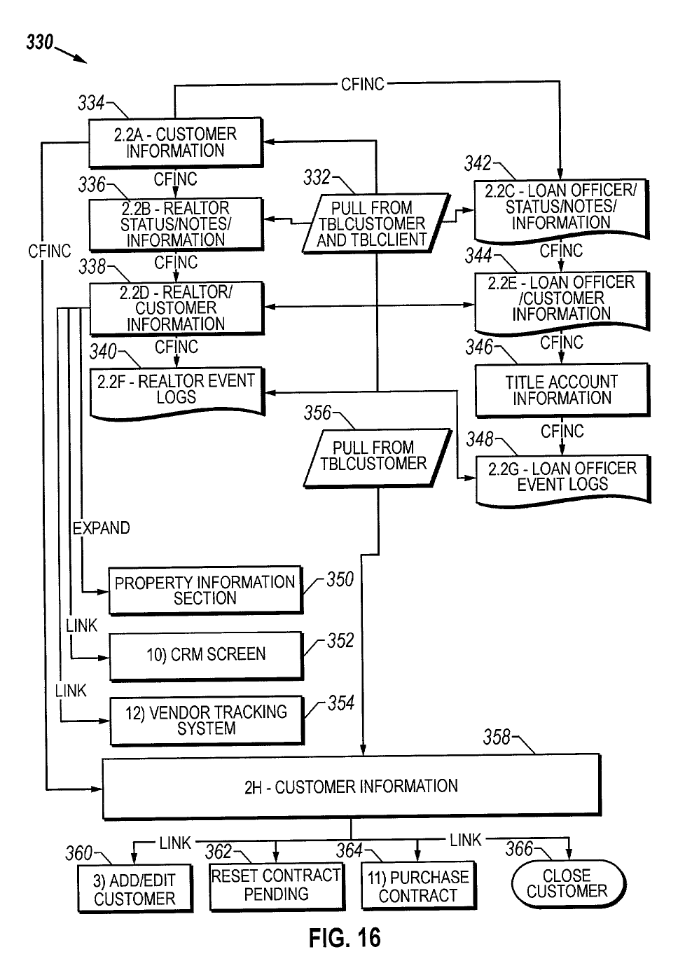

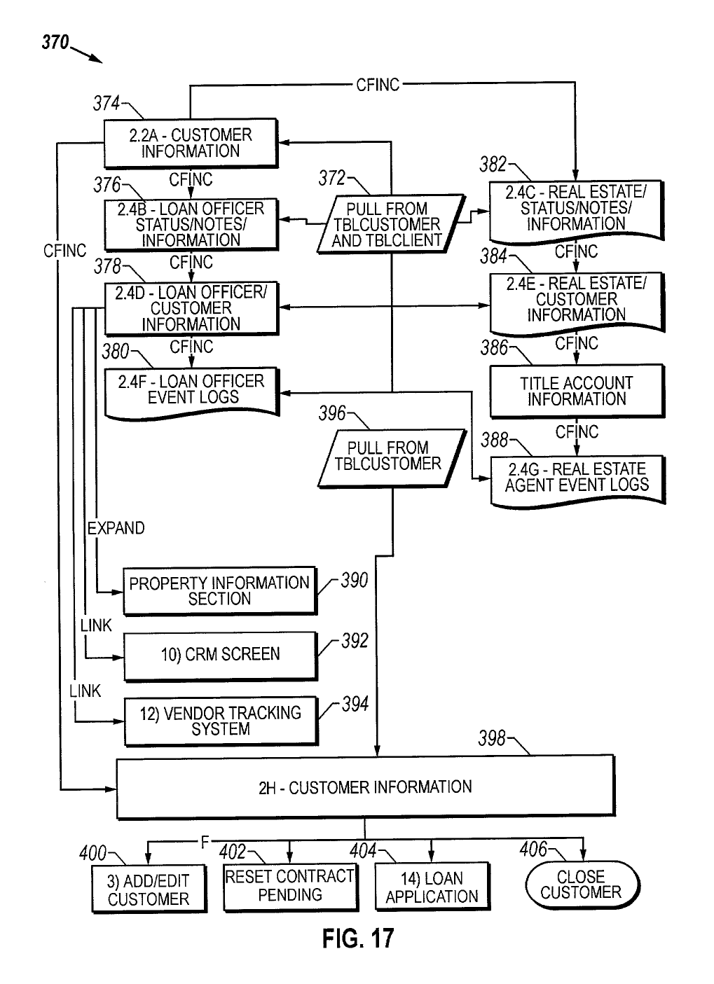

For pending contracts, the data displayed to the realtor and loan officer may differ from that seen in FIGS. 14 and 15. FIGS. 16 and 17 depict the data flow for the agent and loan officer, respectively, wherein the customer has a contract pending.

In the case of the agent, as seen in FIG. 16, the editable information provided to the realtor is similar to that wherein the customer is a prospect. However, the read-only data may also include Title Account Information 346. The Title Account Information may be provided by a third party. In this manner, the realtor may observe activity associated with the loan while not having editing access. Further, links from the realtor/customer information may lead to information about the property 350 or the activity of vendors 354 as opposed to property listings. Furthermore, the nature of a query to the customer table 356 may provide the option to close a client 366 or reset a contract status 362 as opposed to deleting a client 282 or starting a contract 278.

On the loan officer page, as seen in FIG. 17, the change in customer contract status may also provide new options for viewing the actions of a party responsible for title. Here too, the loan officer links from the Loan Officer/ Customer Information 378 may lead to property information 390 and vendor tracking 394 as opposed to appointments scheduling, pre-qualification and credit file accessing. The customer table query may also lead to option changed in resetting contract status 402 and closing a transaction 406.

In this manner, users with varying job functions may view in a single screen the data for which they are responsible and that for which others are responsible. With this invention, users may collaborate more successfully, each performing their respective job function in a more efficient manner.

As such, a system and method displaying data in a collaborative work environment is described. In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

What is claimed is:

1. A system for interactively sharing customer information among multiple users, the system comprising,
a plurality of data fields in a database, the plurality of data fields in the database storing the customer information;
an associated access identification associated with at least one of the multiple users, the associated access identification associated with reading and editing permissions associated with at least one subset of the plurality of data fields;
instructions for receiving a request for customer information and the associated access identification of the at least one of the multiple users;
instructions for retrieving from the database the customer information, the customer information comprising a first subset and a second subset organized in a manner associated with the associated access identification of the at least one of the multiple users; and
instructions for composing at least one file of instructions for displaying the first subset of the customer information in an editable format in a first panel on a screen and for displaying the second subset of the customer information in a read-only format in a second panel on the screen.

2. The system of claim 1 wherein the at least one file of instructions comprises HTML.

3. The system of claim 1 wherein the instructions for composing at least one file of instructions comprises Cold Fusion® coding

4. The system of claim 1 wherein the instructions for composing at least one file of instructions comprises ASP® coding.

5. The system of claim 1 wherein the instructions for composing at least one file of instructions comprises PHP coding.

6. The system of claim 1 wherein the first panel and the second panel are cells in a table.

7. The system of claim 1, the system further comprising:
instructions for receiving edited data associated with the first subset of data.

8. The system of claim 7, the system further comprising:
instructions for updating the database.

9. The system of claim 1, the system further comprising:
instructions for composing a second file of instructions for displaying to a second user of the multiple users in accordance with an associated access identification associated with the second user the second subset of the customer information in an editable format in a first panel on a second screen and for displaying the first subset of the customer information in a read-only format in a second panel on the second screen.

10. The system of claim 9 where the second user of the multiple users retrieves the second file of instructions after the first subset of the customer information is updated by the at least one of the multiple users.

11. A instruction file interpretable to display data in a collaborative work environment, the collaborative work environment having at least two users, each of the at least two users having an identifier and a workspace, the identifier being associated with business rules, the data comprising a first and a second subset, the instruction file comprising:
instructions for displaying a first panel within the workspace, the first panel operable to selectively display the first or second subset of the data in an editable format in accordance with business rules associated with the identifier of a user of the at least two users; and
instructions for displaying a second panel within the workspace, the second panel operable to selectively display the first or second subset of the data in a read-only format in accordance with business rules associated with the identifier of the user of the at least two users.

12. The instruction file of claim 11 wherein the instructions comprise HTML.

13. The instruction file of claim 11 wherein the instruction file is coded in Cold Fusion® coding.

14. The instruction file of claim 11 wherein the instruction file is coded in ASP coding.

15. The instruction file of claim 11 wherein the instruction file is coded in PHP coding.

16. The instruction file of claim 11 wherein the first panel and the second panel are cells in a table.

17. The instruction file of claim 11, the instruction file further comprising:
instructions for submitting edited data associated with the first panel.

18. The instruction file of claim 1, the instruction file further comprising:
instructions for retrieving updated data.

19. A method for working in a collaborative work environment, the collaborative work environment having at least two users, each of the at least two users having an identifier, the identifier being associated with business rules, the data comprising a first and a second subset, the method comprising:
receiving the identifier of a user of the at least two users through a website;
requesting data from a database in a format associated with the business rules associated with the identifier, the format selectively applying editing and read-only access to the first and second subset in accordance with the business rules; and
compiling an instruction file, the instruction file operable to selectively display the first or second subset in a first panel in an editable format and to selectively display the first or the second subset in a second panel in a read-only format, the first and second panel being in a single screen.

20. The method of claim 19, the method further comprising:
receiving the identifier of a second user of the at least two users through a website;
compiling a second instruction file, the second instruction file operable to selectively display the first or second subset in opposite panels in opposite formats, the opposite panels being in a second single screen.

21. A method for working in a collaborative work environment, the collaborative work environment having at least one user, the at least one user having an identifier, the method comprising:
receiving the identifier of the at least one user through a website;
associating with the at least one user editing access to a first subset of a customer data;
requesting the first subset and a second subset of the data from a database, the first subset of the data being in an editable format and the second subset of the data being in a read-only format; and
compiling an instruction file, the instruction file operable to display the first subset in a first panel in an editable format and to display the second subset in a second panel in a read-only format, the first and second panel being in a single screen.
